(19) United States
(12) Patent Application Publication
(10) Pub. No.: US 2005/0031175 A1
(43) Pub. Date: Feb. 10, 2005

(54) Input device, electronic apparatus, and method for driving input device

(75) Inventors: Hiroyuki Hara, Chino-shi (JP); Mikio Sakurai, Tsukuba-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/881,108

(22) Filed: Jul. 1, 2004

(30) Foreign Application Priority Data
Jul. 28, 2003 (JP) 2003-280857(P)

(51) Int. Cl. G06K 9/00

(52) U.S. Cl. 382/124

(57) ABSTRACT

To provide an input device, an electronic device, and a method for driving an input device where an increase in the amount of processed information is restricted to make processing systems simple, an input device includes a plurality of capacitive sensing circuits arranged in a matrix and an amp circuit to output detected information from the capacitive sensing circuits. An output processing section performs a plurality of field scans to read fingerprint information from the capacitive sensing circuits and thereby identify particular capacitive sensing circuits to acquire detected information necessary for processing.

### BACKGROUND OF THE INVENTION

1. Field of Invention

The present invention relates to input devices. In particular, the present invention relates to an input device having sensor cells arranged in a matrix, an electronic apparatus, and a method for driving an input device.

2. Description of Related Art

Typical input devices having sensor cells arranged in a matrix include a fingerprint sensor (see, Japanese Unexamined Patent Application Publication No. 11-118415, Japanese Unexamined Patent Application Publication No. 2000-346608, Japanese Unexamined Patent Application Publication No. 2001-56204, and Japanese Unexamined Patent Application Publication No. 2001-133213), a seat pressure sensor to measure the pressure distribution on a chair, etc. Fingerprint sensors have mainly been used in a system for authenticating individuals who wish to enter a highly restricted room. Recent capacitive fingerprint sensors with semiconductors (see, Japanese Unexamined Patent Application Publication No. 2000-346608, Japanese Unexamined Patent Application Publication No. 2001-56204, and Japanese Unexamined Patent Application Publication No. 2001-133213) are compact, lightweight, and inexpensive, and will be applicable to portable compact electronic apparatus, such as mobile phones, personal digital assistants (PDAs), portable personal computers, as well as IC cards. In addition, fingerprint sensors to identify individuals are used even in stationary electronic devices to protect privacy for personal use.

Related art capacitive fingerprint sensors with semiconductors are formed on a single-crystal silicon measuring about 20 mm×20 mm. The structure and the detection principle of a capacitive fingerprint sensor are as follows. The distribution of capacitance generated between electrodes provided in matrix of sensor cells formed on the surfaces of semiconductors and ridges/valleys of a fingerprint through dielectric thin films formed above the electrodes is detected in transistor circuits. Detected information from the sensor cells is output by sequentially scanning the matrix sensor cells using scanning lines to sequentially connect data lines to output terminals of the sensor cells (see, Japanese Unexamined Patent Application Publication No. 11-118415).

### SUMMARY OF THE INVENTION

Unfortunately, these related art capacitive fingerprint sensors have sensor electrodes and dielectric films formed on a single-crystal silicon substrate, which may break if a finger is strongly pressed onto the dielectric films, that is, the detection surface. In short, the durability of the related art capacitive fingerprint sensors is poor. Furthermore, due to its application, a fingerprint sensor is required to have a size of about 20 mm×20 mm. This requirement causes the fingerprint sensor to become expensive when it is formed on a single-crystal silicon substrate which requires a huge amount of energy and labor to produce.

In order to address the disadvantages described above, the applicant of the present invention has proposed a capacitive fingerprint sensor which can be formed even on a low-cost and durable glass substrate or plastic substrate by using MIS thin film semiconductor devices (signal-amplifying TFT) as sensor cells. This fingerprint sensor, however, is constructed such that ridge and valley information (fingerprint information) of a fingerprint is read from all sensor cells arranged in a matrix. Fingerprint authentication is usually performed by using fingerprint information regarding only the center area of a finger. For this reason, if authentication is performed by reading fingerprint information from all sensor cells, a processing system for the fingerprint authentication becomes complicated due to an increase in the amount of processed information.

In view of the issues and factors described above, the present invention provides an input device, an electronic apparatus, and a method for driving an input device that still restrict an increase in the amount of processed information to make the processing system simple.

According to an aspect of the present invention, an input device includes a plurality of sensor cells arranged in a matrix, an output device to output detected information from the sensor cells, and a selection device to perform a plurality of field scans to read the detected information from the sensor cells, identify particular sensor cells, and read detected information from the particular sensor cells.

According to an aspect of the present invention, a method for driving an input device to output detected information from a plurality of sensor cells arranged in a matrix includes performing a plurality of field scans to read the detected information from the sensor cells, identifying particular sensor cells based on the read detected information, and reading detected information for processing from the particular sensor cells.

According to an aspect of the present invention, at least two field scans are performed on the plurality of sensor cells arranged in an m-row×n-column matrix. The detected information is used to identify particular sensor cells from among all sensor cells. Various processing is performed based on the detected information only from these identified sensor cells. Thus, the amount of processed information is minimized, and therefore processing systems can be made simple.

In the input device according to an aspect of the present invention, the selection device includes a preprocessing device to read the detected information from all sensor cells in the first field scan to determine particular sensor cells to be selected and a postprocessing device to read the detected information from the determined particular sensor cells in the second and the subsequent field scans.

According to an aspect of the present invention, the method for driving an input device to output detected information from a plurality of sensor cells arranged in a matrix includes reading detected information from all sensor cells by performing the first field scan on the sensor cells to determine particular sensor cells to be selected based on that read detected information; and performing the second and, if necessary, the subsequent field scan(s) to read detected information for processing from the particular sensor cells.

According to an aspect of the present invention, it is only through the first field scan that the detected information is read from all sensor cells. At the second and the subsequent field scans, detected information is read only from the particular sensor cells for processing. In short, the sensor cells for processing can be identified through one field scan only.

According to an aspect of the present invention, the preprocessing device compares the detected information read from all the sensor cells with a predetermined threshold to determine the particular sensor cells to be selected.

According to an aspect of the present invention, in the method for driving an input device, detected information read from all sensor cells is compared with a predetermined threshold to determine particular sensor cells to be selected.

According to an aspect of the present invention, it is possible to more accurately identify the particular sensor cells by comparing the detected information read from all sensor cells with the predetermined threshold.

According to an aspect of the present invention, the sensor cells may be disposed at respective intersections of a plurality of scanning lines and a plurality of data lines. Furthermore, a scan driver to scan the scanning lines and a data driver to connect the data lines to the output device may be included. Thus, the postprocessing device may drive the scan driver and the data driver such that only the scanning lines corresponding to the particular sensor cells are scanned to read the detected information only from the data lines corresponding to the particular sensor cells.

In the method for driving an input device according to an aspect of the present invention, the sensor cells may be disposed at respective intersections of a plurality of scanning lines and a plurality of data lines. Furthermore, only the scanning lines corresponding to the particular sensor cells may be scanned and then detected information may be read from the data lines corresponding to the particular sensor cells.

According to an aspect of the present invention, in the second and the subsequent field scans, only the scanning lines corresponding to the particular sensor cells are selected and scanned and then detected information is read by connecting only corresponding data lines to an output device. Thus, an operation associated with scanning of the sensor cells, other than the particular sensor cells and the reading of detected information from the data lines corresponding to the sensor cells, is prevented to reduce the power consumption associated with the driving of the sensor cells.

According to an aspect of the present invention, the sensor cells may be disposed at respective intersections of a plurality of scanning lines and a plurality of data lines. Furthermore, a scan driver to sequentially scan the scanning lines and a data driver to sequentially connect the data lines to the output device may be included. Thus, the postprocessing device may drive the scan driver and the data driver such that all scanning lines are scanned where the scanning lines corresponding to the sensor cells other than the particular sensor cells are scanned at a higher speed than that of the scanning lines corresponding to the particular sensor cells to read the detected information from the data lines corresponding to the particular sensor cells.

In a method for driving an input device according to an aspect of the present invention, the sensor cells may be disposed at respective intersections of a plurality of scanning lines and a plurality of data lines. Furthermore, all scanning lines may be scanned such that the scanning lines corresponding to the sensor cells, other than the particular sensor cells, are scanned at a higher speed than that of the scanning lines corresponding to the particular sensor cells, to read the detected information from the data lines corresponding to the particular sensor cells.

According to an aspect of the present invention, all scanning lines are sequentially scanned in the second and the subsequent field scans. In this case, however, the scanning lines corresponding to the sensor cells from which detected information is not read are scanned at a higher speed than that of the scanning lines corresponding to the sensor cells from which detected information is read. In this manner, detected information is read from the data lines corresponding to the particular sensor cells. Thus, unnecessary operation associated with scanning of the sensor cells and the reading of detected information from the data lines is prevented to reduce the power consumption associated with the driving of the sensor cells.

In the above-described aspects of the present invention, the sensor cells can detect various types of physical quantity. The sensor cells may be applied particularly to a fingerprint sensor to detect ridges and valleys of a fingerprint. This allows for various controls with the fingerprint information as detected information. When a fingerprint sensor to output fingerprint information is used, an extremely small and lightweight input device can be provided.

According to an aspect of the present invention, an input device including a fingerprint sensor can be incorporated in various electronic apparatus.

These electronic apparatus may be, for example, Smart Cards, PDAs, or mobile phones, which are provided as extremely small and lightweight electronic apparatus.

### BRIEF DESCRIPTION OF THE DRAWINGS

FIG. 1 is an illustration showing the overall structure of a fingerprint sensor according to a first exemplary embodiment;

FIG. 2 is a circuit schematic of a capacitive sensing circuit;

FIG. 3 is a circuit schematic of an amp circuit;

FIG. 4 is a schematic of the structure of an input device;

FIG. 5 is a schematic showing an exemplary application to a Smart Card;

FIG. 6 is a flowchart showing the processing flow by an input device;

FIG. 7 is timing chart of a scan driver;

FIG. 8 is a schematic showing the position at which fingerprint information is acquired;

FIG. 9 is a schematic showing the overall structure of a fingerprint sensor according to a second exemplary embodiment;

FIG. 10 is a schematic of the structure of an input device;

FIG. 11 is a timing chart of a scan driver; and

FIG. 12 is a schematic showing the position at which fingerprint information is acquired.

### DETAILED DESCRIPTION OF EXEMPLARY EMBODIMENTS

Exemplary embodiments according to the present invention will now be described in detail with reference to the attached drawings. The exemplary embodiments described below do not confine the scope of the present invention. Not all structures described below may be required for the present invention. The exemplary embodiments describe a method to select only a particular portion of a detected section necessary for authentication. The method is achieved by using a new driving technique different from the related art while the circuit structure of a related art sensor section is still used.

First Exemplary Embodiment

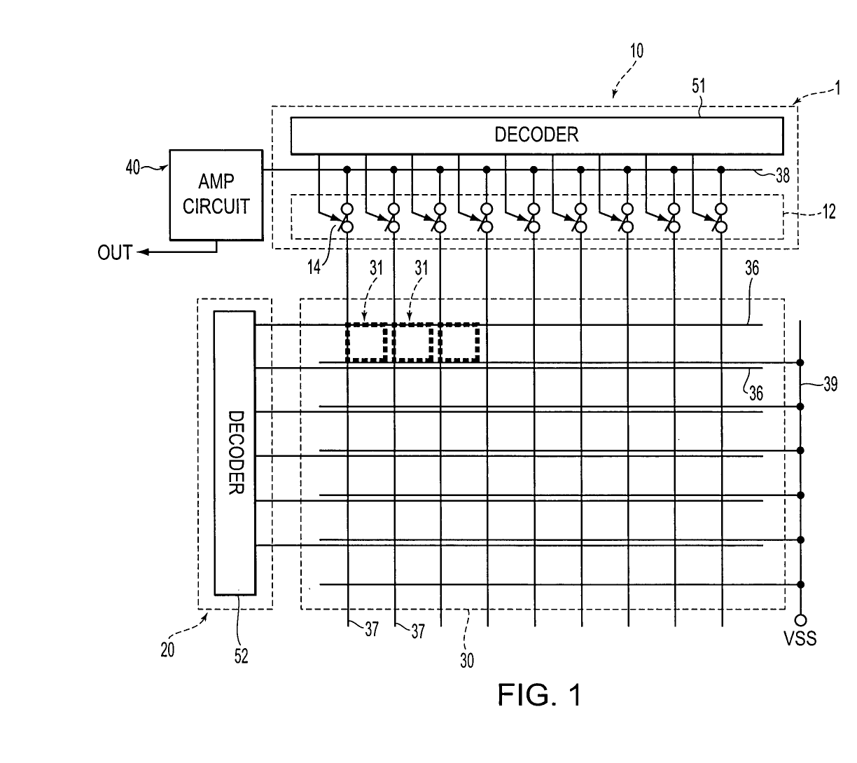

FIG. 1 is a schematic of a capacitive fingerprint sensor 1, which functions as a sensor section of an input device. The fingerprint sensor 1 includes a data driver 10 to select data lines 37, a scan driver 20 to select scanning lines 36, an active matrix 30 formed as a detection area of a detection object, such as a fingerprint, and an amp circuit 40 to amplify a detection signal from the active matrix 30. The active matrix 30, which functions as an information-collecting section to collect the pattern of the surface of a finger, includes the m (two or larger integer) scanning lines 36 and the n (two or larger integer) data lines 37 arranged in an m-row×n-column matrix and capacitive sensing circuits 31 corresponding to the sensor cells provided at the intersections between the scanning lines 36 and the data lines 37. Each of the capacitive sensing circuits 31 has a supply line 39 connected to a low-voltage power supply (not shown in the figure). A potential difference between a high potential VDD generated in the active scanning line 36 and a low voltage VSS generated in the supply line 39 is applied to the capacitive sensing circuit 31.

The data driver 10 includes a data decoder 51 to select any data line 37 with a digital-code signal, and analog switches 12 in an array where one switching element 14 is inserted into and connected to, each of the data lines 37. One end of each of the data lines 37 is connected to a common main data line 38, which is connected to the input end of the amp circuit 40. Upon sequentially receiving an appropriate selection signal from the data decoder 51, each of the N switching elements 14 electrically connects the selected data line 37 and the main data line 38. The scan driver 20 includes a scan decoder 52 to select any scanning line 36 with a digital-code signal. Thus, the amp circuit 40 acquires detected information through the main data line 38 from the capacitive sensing circuit 31 at the intersection between the active scanning line 36 and the selected data line 37.

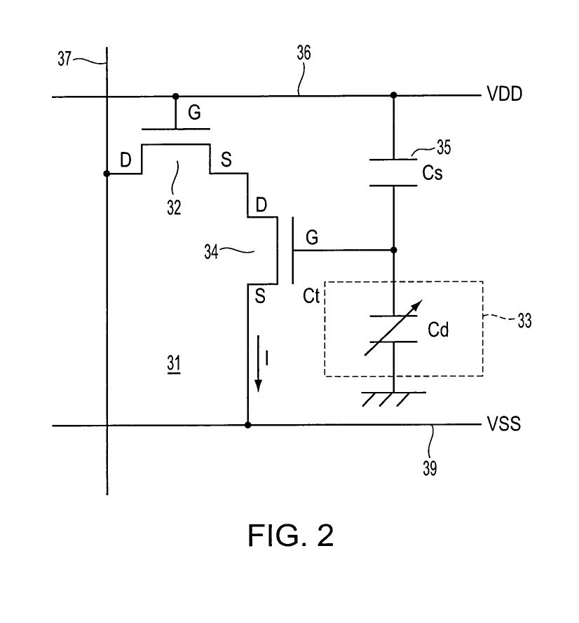

The capacitive sensing circuits 31 are arranged in an m-row by n-column matrix in the active matrix 30 and detects a capacitance which varies depending on the distance to the detection object. In more detail, as shown in FIG. 2, the capacitive sensing circuits 31 each include a selection transistor 32 as a selecting element, a signal-detecting element 33 whose capacitance Cd changes depending on the shape of irregularities on the surface of a detection object, such as a fingerprint, a signal-amplifying transistor 34 as a signal-amplifying element, and a reference capacitor 35 having a fixed capacitance Cs. The signal-amplifying transistor 34 may be formed by a signal-amplifying MIS thin film semiconductor device which includes a gate electrode, a gate insulating film, and a semiconductor film. The selection transistor 32 may be formed by a selection MIS thin film semiconductor device which includes a gate electrode, a gate insulating film, and a semiconductor film. According to an aspect of the present invention, the drain of the signal-amplifying MIS thin film semiconductor device is connected to the source of the selection MIS thin film semiconductor device, the source of the signal-amplifying MIS thin film semiconductor device is connected to a supply line 39, and the gate electrode of the signal-amplifying MIS thin film semiconductor device is connected to a node between the signal-detecting element 33 functioning as a capacitance-detecting electrode and the reference capacitor 35 (the source, drain, and gate electrode of the MIS thin film semiconductor devices in FIG. 2 are denoted as S, D, and G, respectively). Thus, the source of the selection MIS thin film semiconductor device and the supply line 39 are coupled to each other through the signal-amplifying MIS thin film semiconductor device which senses an electric charge Q detected at the capacitance-detecting electrode. According to an aspect of the present invention, the drain of the selection MIS thin film semiconductor device is connected to the data line 37 and the gate electrode of the selection MIS thin film semiconductor device is connected to the scanning line 36 and one end of the reference capacitor 35.

According to an aspect of the present invention, the gate potential of the signal-amplifying MIS thin film semiconductor device is changed by the electric charge Q induced between the capacitor with capacitance Cs and the capacitor with capacitance Cd which varies depending on the shape of the surface of the detection object. When the source and the drain of the selection MIS thin film semiconductor device are electrically coupled to each other and a predetermined voltage is applied to the drain of the signal-amplifying MIS thin film semiconductor device, a current I that flows through the drain and the source of the signal-amplifying MIS thin film semiconductor device is greatly amplified depending on the induced electric charge Q. The induced electric charge Q itself is stored without flowing anywhere. Hence the current I can easily be measured by, for example, increasing the drain voltage or extending the measurement time.

The above-described MIS thin film semiconductor devices including a metal, an insulating film, and a semiconductor film are typically formed on a glass substrate, and are known as a technology to manufacture low-cost, large-area semiconductor integrated circuits. In fact, MIS thin film semiconductor devices are now used in apparatus such as liquid crystal displays. For the reasons described above, if a capacitive sensing circuit 31, which is applicable to fingerprint sensors or the like, is formed by a thin film semiconductor device, it is not necessary to use a single-crystal silicon substrate, which is produced requiring a huge amount of energy and labor. Therefore, a low-cost device, such as a fingerprint sensor can be produced without wasting valuable earth resources. Furthermore, with a thin film semiconductor device, a semiconductor integrated circuit can be formed on a plastic substrate by a transfer technique called SUFTLA (see Japanese Unexamined Patent Application Publication No. 11-312811 or S. Utsunomiya et. al. Society for Information Display p.916 (2000)), and the capacitive sensing circuit 31 is not restricted to using a single-crystal silicon substrate. Instead it can be formed on a plastic substrate.

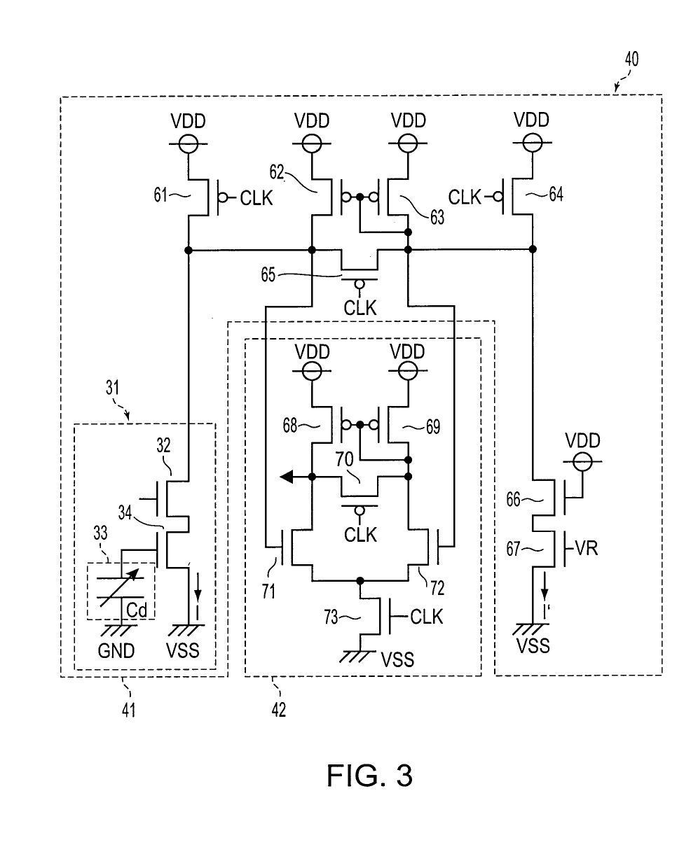

FIG. 3 is a circuit schematic of the amp circuit 40. The amp circuit 40 includes two current mirror circuits 41 and 42, where the first current mirror circuit 41 includes a capacitive sensing circuit 31. In more detail, in addition to the capacitive sensing circuit 31, the current mirror circuit 41 includes P-channel transistors 61 to 65; N-channel transistors 66 and 67; a series circuit between the high potential VDD line and the low voltage VSS line where a transistor 61, a selection transistor 32, and a signal-amplifying transistor 34 are connected in that order; and another series circuit between the high potential VDD line and the low voltage VSS line where transistors 64, 66, and 67 are connected in that order. Furthermore, the drain of the transistor 65 is connected to a node between the transistors 61 and 32. The source of the transistor 65 is connected to a node between the transistors 64 and 66. A clock CLK is applied to each of the gates of the transistors 61, 64, and 65. The drain of the transistor 62 is connected between the high potential VDD line and the drain of the transistor 65. The drain of the transistor 63 is connected between the high potential VDD line and the source of the transistor 65. The gates of the transistors 62 and 63 are connected to the drain of the transistor 63. Then, when the clock CLK is at the H (high) level, a voltage is produced between the drain and the source of the transistor 65 by the difference between the current I, which flows through the transistors 32 and 34 in the capacitive sensing circuit 31, and the current I′, which flows through the transistors 66 and 67 by the reference voltage VR applied to the gate of the transistor 67.

The second current mirror circuit 42 includes P-channel transistors 68 to 70 and N-channel transistors 71 to 73. A series circuit of transistors 68 and 71 and another series circuit of transistors 69 and 72 are connected between the high potential VDD line and the drain of the transistor 73. Furthermore, the drain of the transistor 70 is connected to a node between the transistors 68 and 71. The source of the transistor 70 is connected to a node between the transistors 69 and 72. A clock CLK is applied to each of the gates of the transistors 70 and 73. Furthermore, the gates of the transistors 68 and 69 are connected to the drain of the transistor 69. The source of the transistor 73 is connected to the low voltage VSS line. Then, when the clock CLK is at the H level, a voltage corresponding to the difference between the currents I and I′ is applied to each of the gates of the transistors 71 and 72. Thereby an amplified output OUT is acquired from the node between the transistors 68 and 71. The amp circuit 40 shown in the figure is only an example. Another circuit structure may be used instead.

The operation of the fingerprint sensor 1 is now described. A particular scanning line 36 is sequentially selected from among the m scanning lines 36 by applying the digital-code signal to the scan driver 20. Thus, the selected scanning line 36 becomes active to have the high potential VDD. As a result, the selection amp transistor 32 of the capacitive sensing circuit 31 connected to the selected scanning line 36 becomes ON. The gate voltage of the signal-amplifying transistor 34 is determined by the ratio among the parasitic capacitance Ct (refer to FIG. 2) in the signal-amplifying transistor 34, the capacitance Cs of the reference capacitor 35, and the capacitance Cd of the signal-detecting element 33.

When a ridge of the fingerprint is in contact with the surface of the capacitive sensing circuit 31, the capacitance Cd of the signal-detecting element 33 becomes high enough compared with the capacitances Ct and Cs to bring the gate voltage of the signal-amplifying transistor 34 close to the GND (ground) potential. As a result, the signal-amplifying transistor 34 becomes substantially OFF. Hence an extremely low current I flows through the drain and the source of the signal-amplifying transistor 34. By measuring this current I, the measurement point is determined to be at a ridge of the fingerprint pattern. When a valley of the fingerprint is in contact with the surface of the capacitive sensing circuit 31, the capacitance Cd of the signal-detecting element 33 becomes low enough compared with the capacitances Ct and Cs to bring the gate voltage of the signal-amplifying transistor 34 close to the high potential VDD. As a result, the signal-amplifying transistor 34 becomes substantially ON. Hence a large current I flows through the drain and the source of the signal-amplifying transistor 34. By measuring this current I, the measurement point is determined to be at a valley of the fingerprint pattern.

Here, the source of the signal-amplifying transistor 34 is connected to the supply line 39 having the low voltage VSS. Hence the current I flows in the direction from the data line 37 to the capacitive sensing circuit 31. When a digital-code signal is applied to the data driver 10 while a particular scanning line 36 is active, a particular analog switch 12 is sequentially selected from among the n analog switches 12 connecting through the data lines 37 and the amp circuit 40 and becomes active. As a result, the current I depending on the ridge and valley information of the fingerprint flows from the amp circuit 40 towards the capacitive sensing circuit 31 through the active analog switch 12. The amp circuit 40, functioning as an output section to output detected information from the capacitive sensing circuits 31, includes the two current mirror circuits 41 and 42 described above. In the first current mirror circuit 41, when an H-level clock CLK is applied, the current I flowing towards the capacitive sensing circuit 31 is compared with the current I′ flowing towards the transistors 66 and 67 by the reference voltage VR. This comparison result is applied to the gates of the transistors 71 and 72 in the second current mirror circuit 41, and an amplified output OUT is acquired.

Here, the structure of the amp circuit 40 is described in more detail. When the clock CLK is at the L level, both transistors 61 and 64 come ON. The transistor 65 also becomes conductive. Thus both ends (source and drain) of the transistor 65 become the H level. This voltage is applied to the second current mirror circuit 42, where the transistor 73 is OFF and the transistor 70 is ON, and hence the output becomes close to the threshold voltage of the transistors 68 and 69.

When the clock CLK is at the H level, both transistors 61 and 64 go OFF. The transistor 65 also goes OFF, and the difference between the current I flowing through the transistors 32 and 34 in the capacitive sensing circuit and the current I′ flowing through the transistors 66 and 67 by the reference voltage VR which is applied to the gate of the transistor 67 is generated between both ends (source and drain) of the transistor 65. This voltage is applied to the gates of the transistors 71 and 72 in the second current mirror circuit 42. The transistor 73 comes ON to function as a resistor, while the transistor 70 remains OFF. Therefore, the voltage applied to the gates of the transistors 71 and 72 is amplified and output from the drain of the transistor 71.

The fingerprint pattern on the surface of the active matrix 30 is detected by repeatedly performing the above-described operation on each of the m-row×n-column capacitive sensing circuits 31 in the active matrix 30. In more detail, ridges and valleys of the fingerprint are sequentially detected for each sensor cell. For example, fingerprint ridges and valleys are detected starting with the capacitive sensing circuits 31 located in the columns of the first row, followed by the capacitive sensing circuits 31 located in the columns of the second row. As a result, a fingerprint image can be periodically acquired using the fingerprint sensor 1.

The capacitive sensing circuits 31 can be formed on a plastic substrate using the above-described SUFTLA technology. Since, in general, a fingerprint sensor based on single-crystal silicon technology easily breaks or has only a limited size if it is used on a plastic substrate, its practical usability is poor. In contrast, capacitive sensing circuits 31 formed on a plastic substrate according to this exemplary embodiment do not break, while still having a size large enough to receive a finger on the plastic substrate, and therefore can be used for the fingerprint sensor 1 on the plastic substrate.

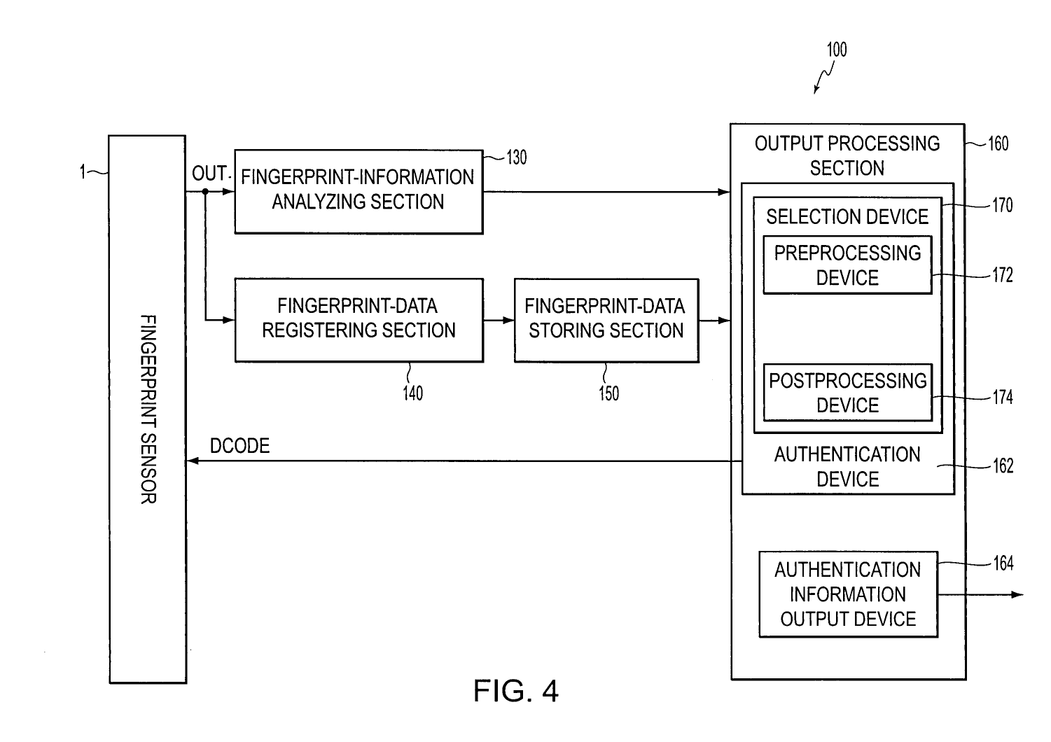

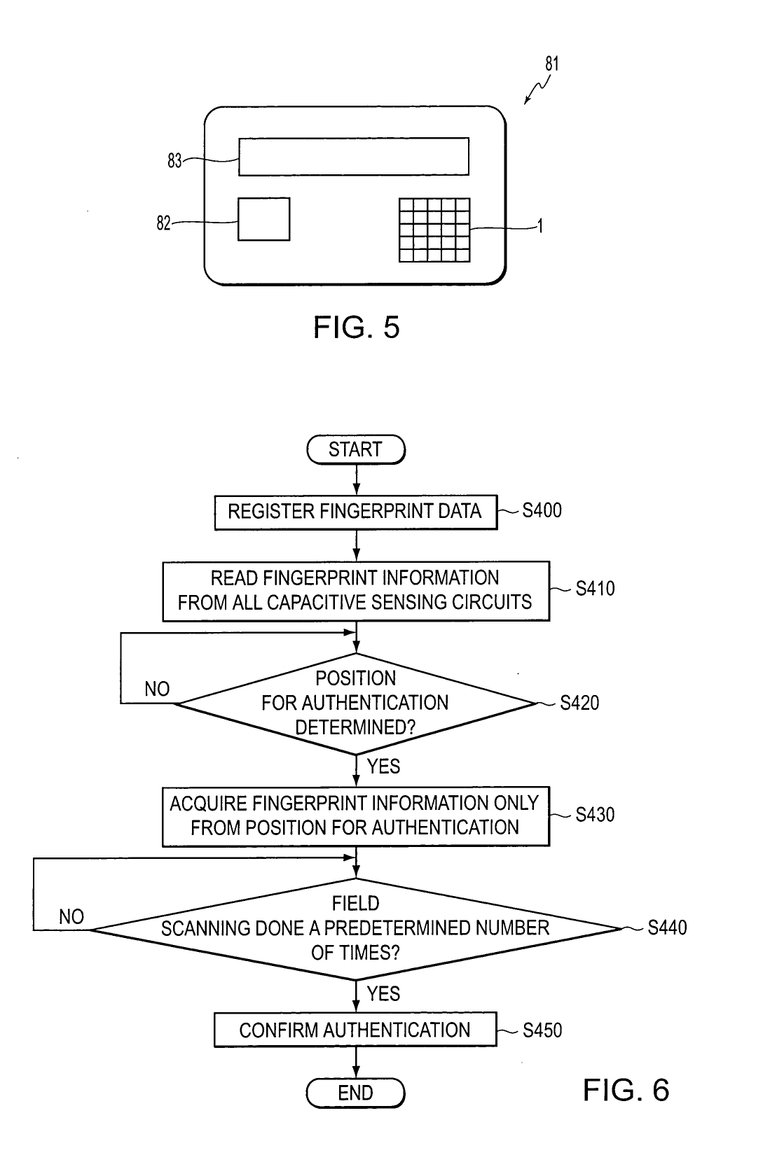

Detected information (fingerprint information) read from the fingerprint sensor 1 can be used in various processing systems connected to the fingerprint sensor 1. FIG. 4 shows the outline of an input device including the fingerprint sensor 1. An input device 100 according to this exemplary embodiment compares an image of the fingerprint information read from the fingerprint sensor 1 with an image of the registered fingerprint data, and outputs authentication information as control information according to the comparison result. Furthermore, according to this exemplary embodiment, a digital-code signal can be output from a processing system to the data driver 10 and the scan driver 20 to specify from which capacitive sensing circuit 31 and in which order fingerprint information is to be acquired. For this purpose, the input device 100 includes a fingerprint-information analyzing section 130, a fingerprint-data registering section 140, a fingerprint-data storing section 150, and an output processing section 160, in addition to the fingerprint sensor 1 functioning as a fingerprint-information capturing section.

The fingerprint-information analyzing section 130 analyzes field-by-field fingerprint information acquired from the fingerprint sensor 1, and outputs the analysis result to the output processing section 160. The fingerprint-data registering section 140 performs the registration of fingerprint data. In more detail, the fingerprint-data registering section 140 makes up one item of fingerprint data by combining the output OUT associated with each site of the detected object acquired from the fingerprint sensor 1 and then registers the combined fingerprint data. The fingerprint-data storing section 150 stores the fingerprint data registered by the fingerprint-data registering section 140. The output processing section 160 includes an authentication circuit to perform authentication by matching the fingerprint information acquired from the fingerprint sensor 1 against the fingerprint data stored in the fingerprint-data storing section 150. This authentication circuit corresponds to the authentication device 162 in the figure. The output processing section 160 further includes an authentication information output device 164 to output the result of authentication by the authentication device 162 as authentication information.

The authentication device 162 according to this exemplary embodiment includes a selection device 170 to control an increase in the amount of processed information in the output processing section 160 to make the processing systems simple. Through at least two field scans based on a digital-code signal DCODE supplied to the fingerprint sensor 1, this selection device 170 reads fingerprint information from all or some of the capacitive sensing circuits 31 arranged in an m-row×n-column matrix and identifies the capacitive sensing circuits 31 located at the positions required for fingerprint authentication. The selection device 170 is provided with a function to efficiently acquire detected information necessary for fingerprint authentication from among the identified capacitive sensing circuits 31. With the selection device 170 added, through at least two field scans, the position of the detection section required for processing can be identified based on detected information acquired from the detection section. Therefore detected information is efficiently acquired from the identified detection section only.

The selection device 170 provides the digital-code signal DCODE to perform at least two field scans on the fingerprint sensor 1. The selection device 170 includes two functions. One is fulfilled by a preprocessing device 172 to perform the first field scan and the other is fulfilled by a postprocessing device 174 to perform the second and, if necessary, the subsequent field scan(s). The preprocessing device 172 reads fingerprint information from all capacitive sensing circuits 31 in the first field scan, and then compares the read fingerprint information with fingerprint data as a threshold prestored in the fingerprint-data storing section 150 to determine particular capacitive sensing circuits 31 to be selected for authentication. This enables such particular capacitive sensing circuits 31 to be more accurately identified by comparing the fingerprint information read from all capacitive sensing circuit 31 with the predetermined threshold. The postprocessing device 174 acquires fingerprint information for fingerprint authentication from the particular capacitive sensing circuits 31 in the second and the subsequent field scans. In particular, according to this exemplary embodiment, based on the digital-code signal applied to the data driver 10 and the scan driver 20 by the postprocessing device 174, only the scanning lines 36 corresponding to the particular capacitive sensing circuit 31 necessary for processing are scanned and only the data lines 37 corresponding to the particular capacitive sensing circuits 31 are connected to the main data line 38 via switching elements 14. In short, neither scanning by the scan driver 20 nor the acquisition of fingerprint information via the data driver 10, is performed for the capacitive sensing circuits 31 other than the identified particular capacitive sensing circuits 31. This prevents unnecessary operation for the fingerprint sensor 1, thus reducing the power consumption for driving the capacitive sensing circuits 31.

The above-described input device 100 is applied to a Smart Card having a personal authentication function. Smart Cards are used as cash cards (bankcard), credit cards, identification cards (identity card), etc. A Smart Card has a superior function to prevent fingerprint information regarding an individual from leaking out of the card, as well as maintaining a significantly increased security level.

FIG. 6 shows an exemplary application to a Smart Card 81. A capacitive fingerprint sensor 1, an IC chip 82, a display device 83, such as a liquid crystal display are provided on the surface of a parent material 80. Each section of the input device 100 other than the fingerprint sensor 1 shown in FIG. 4 is embedded into the IC chip 82.

A card that does not involve personal authentication can serve its function when the personal identification number preregistered in the card is identical to the personal identification number entered by the user of the card. This means that anyone, in addition to the owner of the card, can illegally use the card if he or she knows the personal identification number.

For a card which requires personal authentication with the fingerprint sensor 1, the personal identification number is issued only when the fingerprint data prestored in the memory of the card matches the fingerprint information from the fingerprint sensor 1. If this issued personal identification number is identical to the personal identification number entered by the user of the card, the card can be used.

FIG. 6 shows a processing flow by the input device 100 according to this exemplary embodiment. A program to perform the processing in FIG. 6 is stored in a storage device (not shown) of the IC chip 82. This program is executed by a CPU (not shown) provided in the IC chip 82.

First, the input device 100 registers a fingerprint of the user to be authenticated in a registration mode under control of the fingerprint-data registering section 140. In that case, one image of a fingerprint on a three-dimensional finger is registered as fingerprint data. For this purpose, images of individual sites of the finger are acquired to generate one integrated group of fingerprint data. Specifically, the fingerprint-data registering section 140 acquires fingerprint information from the fingerprint sensor 1 when the finger is pressed at a natural angle relative to the surface (detection surface) of the active matrix 30. Similarly, fingerprint information is acquired in each of the cases where the finger is pressed inclined as much as possible to the left, to the right, to the near side, and to the far side. The fingerprint-data registering section 140 merges the fingerprint images based on the five items of the fingerprint information to generate one item of fingerprint data, specifically, one registered fingerprint image, which is then stored in the fingerprint-data storing section 150 (step S400).

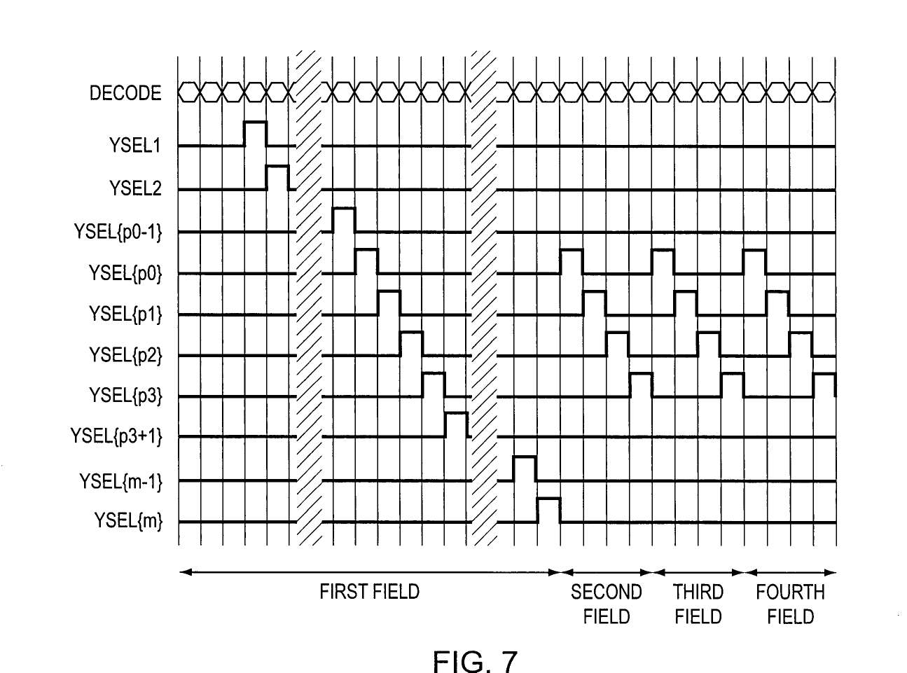

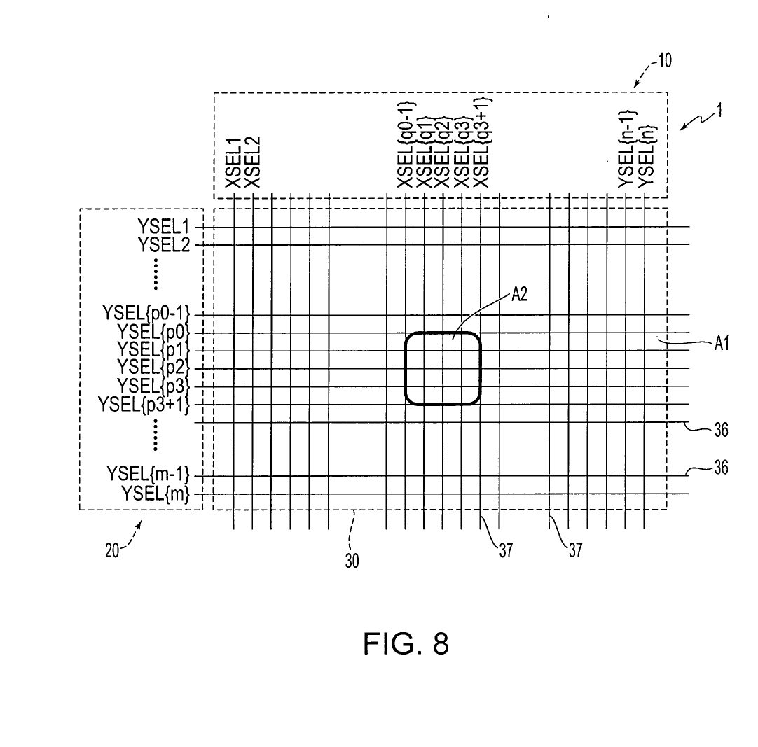

After the registration of the fingerprint data, the authentication device 162 in the output processing section 160 carries out fingerprint authentication. For fingerprint authentication, the authentication device 162 performs at least two field scans on the fingerprint sensor 1 to read fingerprint information from the fingerprint sensor 1 while the finger is placed on the detection surface. FIG. 7 shows a timing chart of the scan driver 20 in the fingerprint sensor 1 performing scanning. In addition, FIG. 8 is a schematic showing the position at which fingerprint information required for fingerprint authentication is acquired. The m scanning lines 36 connected to the scan driver 20 are arranged in order of YSEL1, YSEL2, . . . , YSEL{m−1}, YSEL{m}. Likewise, then data lines 37 connected to the data driver 10 are arranged in order of XSEL1, XSEL2, . . . , XSEL{n−1}, XSEL{n}. A read-out portion A1 is defined on the active matrix 30 by the scanning lines 36 and data lines 37 arranged in a matrix.

At step S410, in order to search for the position for authentication, the authentication device 162 reads ridge and valley information of the fingerprint from all capacitive sensing circuits 31 arranged in the active matrix 30 by scanning the first field immediately after the authentication device 162 starts. This operation is performed by the preprocessing device 172. The preprocessing device 172 outputs a digital-code signal to the scan driver 20 so as to sequentially select all scanning lines 36 in order of YSEL1, YSEL2, . . . , YSEL{m−1}, YSEL{m} and to feed the selected scanning lines 36 one at a time with a supply voltage having the high potential VDD (see the first field in FIG. 7). Then, while one selected scanning line 36 is at the high potential VDD, the preprocessing device 172 sequentially selects all data lines 37 in order of XSEL1, XSEL2, . . . , XSEL{n−1 }, XSEL{n} by applying the digital-code signal DCODE to the data driver 10, and thus turns ON the switching elements 14 connected to the selected data lines 37. This enables ridge and valley information of the fingerprint to be read from all capacitive sensing circuits 31 at the intersections between the selected scanning line 36 and the selected data lines 37.

This fingerprint information is amplified by the amp circuit 40, is output from the fingerprint sensor 1, and is then acquired by the fingerprint-information analyzing section 130. The preprocessing device 172 identifies the two-dimensional positions of the capacitive sensing circuits 31 necessary for fingerprint authentication based on the fingerprint information analyzed by the fingerprint-information analyzing section 130. The determination of the positions of the sensor cells necessary for authentication may be based on, for example, the profile or some other characteristic points of the fingerprint image acquired from the fingerprint sensor 1 by the first field scan. When the particular capacitive sensing circuits 31 to be selected for authentication are determined at step S420, the authentication device 162 performs the second and the subsequent field scans by the postprocessing device 174. Here, it is assumed that the positions YSEL{p0} to YSEL{p3} of the scanning lines 36 are required for fingerprint authentication. Although not shown in the figure, the same determination is performed in the data driver 10, where it is assumed that the positions XSEL{q0} to XSEL{q3} of the data lines 37 are required for fingerprint authentication. FIG. 8 shows a portion A2 for fingerprint authentication determined by the preprocessing device 172.

At step S430, the postprocessing device 174 sends the digital-code signal DCODE to the scan driver 20 and the data driver 10 so that the second and the subsequent field scans after the first field scan are sequentially performed only on the scanning lines 36 corresponding to the particular capacitive sensing circuits 31 required for fingerprint authentication and fingerprint information is acquired only from the data lines 37 corresponding to these particular capacitive sensing circuits 31. The scan decoder 52 in the scan driver 20 does not select the scanning lines 36 (YSEL1 to YSEL{p0−1} and YSEL{p3+1} to YSEL{m}) that are not necessary for fingerprint authentication but selects only the scanning lines 36 (YSEL{p0} to YSEL{p3}) required for fingerprint authentication, and then sequentially feeds these selected scanning lines 36 with a supply voltage having the high potential VDD. Similarly, the data decoder 51 in the data driver 10 does not select the scanning lines 37 (XSEL1 to XSEL{q0−1} and XSEL{q3+1} to XSEL{n}) that are not necessary for fingerprint authentication but selects only the data lines 37 (XSEL{q0} to XSEL{q3}) necessary for fingerprint authentication, and then sequentially turns ON only the switching elements 14 connected to these selected data lines 37. In this manner, the fingerprint information only from the capacitive sensing circuits 31 located at the positions in the portion A2 necessary for fingerprint authentication is output from the amp circuit 40 functioning as an output device.

The field scanning at step S430 may be repeated at least two times (step S440). When a predetermined number (three, for example) of field scans are completed, authentication is performed by the authentication device 162 with respect to the fingerprint data at step S450. The authentication device 162 here averages the fingerprint information acquired in the second and the subsequent field scans to generate a final version of the fingerprint information. This final version of the fingerprint information is compared with the fingerprint data stored previously in the fingerprint-data storing section 150 for authentication based on the fingerprint. The result of authentication is output to the authentication information output device 164 and displayed on, for example, the display device 83.

The fingerprint-data registering section 140 and the output processing section 160 responsible for the processing flow in FIG. 6 may be triggered by detecting, for example, the pressure of the finger placed on the detection surface or the operation of a start switch which is provided on the input device 100.

In the above-described processing flow, the preprocessing device 172 selects only the capacitive sensing circuits 31 corresponding to the finger position required for fingerprint authentication. Due to this, it is not necessary to feed a supply voltage to the capacitive sensing circuits 31 that are not necessary for fingerprint authentication or to operate switching elements 14 for acquiring fingerprint information, and therefore, the fingerprint sensor 1 can be operated at high speed.

The power consumption of the fingerprint sensor 1 can be reduced by preventing unnecessary operation of the data driver 10 and the scan driver 20. Furthermore, an increase in the amount of processed information can be suppressed in processing, such as authentication, where fingerprint information from the fingerprint sensor 1 is used. Thereby the fingerprint authentication system can be made simple.

As described so far, according to this exemplary embodiment, the input device 100 includes the capacitive sensing circuits 31 arranged in a matrix and the amp circuit 40 to output detected information from these capacitive sensing circuits 31. The input device 100 further includes the authentication device 162 as the selection device to perform at least two field scans to read detected information from the capacitive sensing circuits 31, identify particular capacitive sensing circuits 31, and acquire detected information for processing.

In this case, field scanning is performed at least two times on the capacitive sensing circuits 31 arranged in an m-row×n-column matrix. Along with the scanning described above, detected information read from the capacitive sensing circuits 31 is used to partially identify the capacitive sensing circuits 31 necessary for authentication. Various processing, such as authentication, is performed based on the detected information only from these identified capacitive sensing circuits 31. Thus, the amount of processed information is minimized, and therefore the processing systems can be made simple.

This is also achieved by a method for driving the input device 100 to output fingerprint information from each of the capacitive sensing circuits 31 arranged in a matrix. In this method, field scanning is performed at least two times on the capacitive sensing circuits 31 so that fingerprint information is read from the capacitive sensing circuits 31 and particular capacitive sensing circuits 31 are identified based on the read fingerprint information to acquire only fingerprint information necessary for processing.

The authentication device 162 according to this exemplary embodiment includes the preprocessing device 172 to read fingerprint information from all capacitive sensing circuits 31 through the first field scan to determine particular capacitive sensing circuits 31 to be selected for authentication and the postprocessing device 174 to acquire detected information only from the particular capacitive sensing circuits 31 through the second and the subsequent field scans.

With the structure described above, it is only through the first field scan that detected information is read from all capacitive sensing circuits 31. At the second and the subsequent field scans, detected information is acquired only from the particular capacitive sensing circuits 31 for processing. In short, capacitive sensing circuits 31 for authentication can be identified through one field scan only.

This is also achieved by a method including the following. First, the first field scan is performed on the capacitive sensing circuits 31 to read fingerprint information from all capacitive sensing circuits 31 to determine particular capacitive sensing circuits 31 to be selected based on that fingerprint information acquired through the first field scan. Second, the second and the subsequent field scans are performed to acquire fingerprint information for processing only from the particular capacitive sensing circuits 31.

In particular, the preprocessing device 172 may compare the fingerprint information read from all capacitive sensing circuits 31 with a predetermined threshold to determine which particular capacitive sensing circuits 31 are to be selected for authentication. This enables particular capacitive sensing circuits 31 to be more accurately identified by comparing the fingerprint information read from all capacitive sensing circuit 31 with the predetermined threshold. This is also realized by employing, in the above-described first step, a method to identify particular capacitive sensing circuits 31 to be selected by comparing the fingerprint information read from all capacitive sensing circuits 31 with the predetermined threshold.

According to this exemplary embodiment, there are provided a capacitive sensing circuit 31 at each of the intersections between the plurality of scanning lines 36 and the plurality of data lines 37, the scan driver 20 to sequentially scan the scanning lines 36, and the data driver 10 to sequentially connect the data lines 37 to the amp circuit 40. In the structure described above, the postprocessing device 174 drives the scan driver 20 and the data driver 10 so that only the scanning lines 36 that correspond to particular capacitive sensing circuits 31 are sequentially scanned and only the data lines 37 that correspond to the particular capacitive sensing circuits 31 are connected to the amp circuit 40 to acquire fingerprint information.

In this manner, the second and the subsequent field scans are performed on only the scanning lines 36 that correspond to the selected particular capacitive sensing circuit 31 and only the applicable data lines 37 are connected to the amp circuit 40 to acquire fingerprint information. The scanning lines 36 corresponding to the unnecessary capacitive sensing circuits 31 other than the selected particular ones are not scanned and the acquisition of fingerprint information by connecting the data lines 37 to the amp circuit 40 is not performed for such unnecessary capacitive sensing circuits 31. Thus, unnecessary operation associated with scanning of the capacitive sensing circuits 31 and the acquisition of fingerprint information from the data lines is eliminated to reduce the power consumption associated with the driving of the capacitive sensing circuits 31.

This is also achieved by employing the following method in the above-described second step. That is, only the scanning lines 36 corresponding to the particular capacitive sensing circuits 31 are sequentially scanned and fingerprint information is acquired only from the data lines 37 corresponding to the particular capacitive sensing circuits 31.

Second Exemplary Embodiment

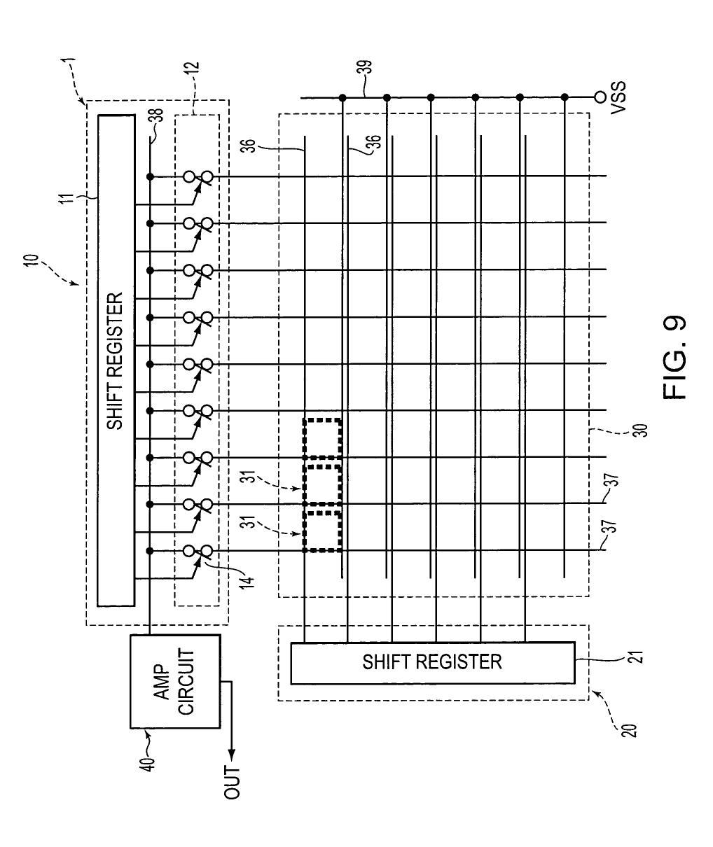

FIG. 9 is a schematic of a capacitive fingerprint sensor 1 according to a second exemplary embodiment of the present invention. In this exemplary embodiment, a shift register 11 to sequentially drive analog dots of a typical display apparatus is provided in the data driver 10 in place of the data decoder 51 described above. Furthermore, the scan driver 20 is provided with a shift register 21 to sequentially select the scanning lines 36 in place of the scan decoder 52. Upon receiving an external start pulse, the shift register 11 sequentially selects and scans all scanning lines 36 in synchronization with another applied clock. The components of the fingerprint sensor 1, other than those described above, including the capacitive sensing circuits 31 and the circuit structure of the amp circuit 40, are the same as in the first exemplary embodiment.

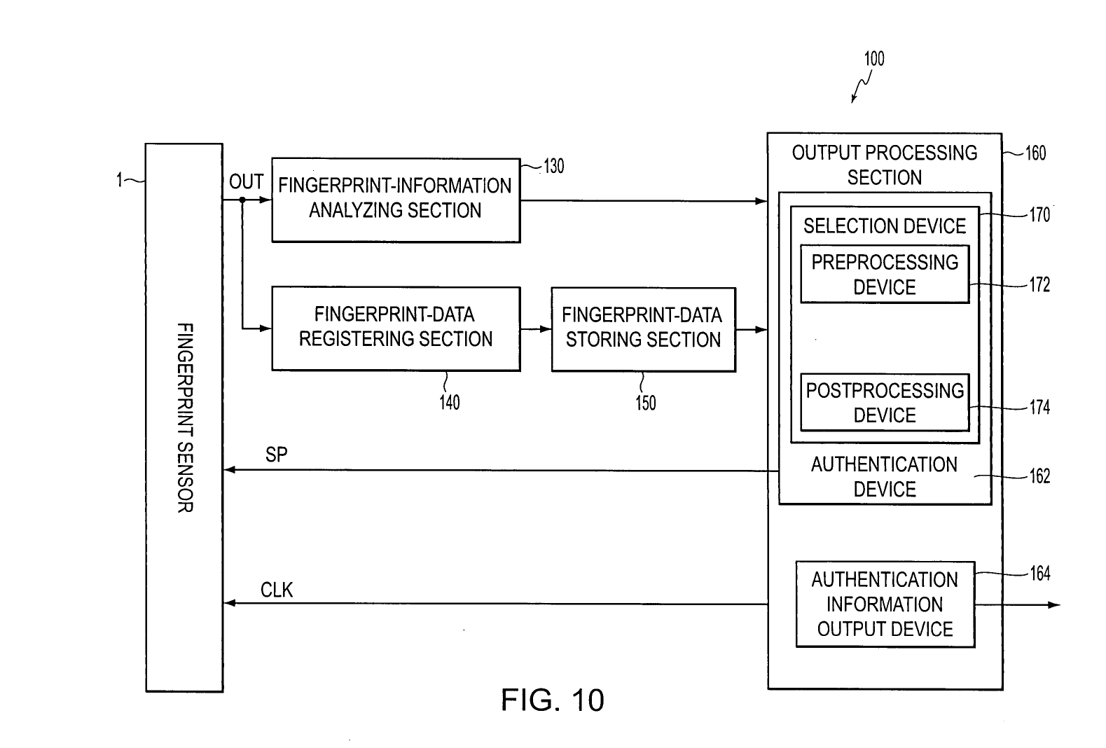

FIG. 10 is a schematic of the structure of an input device. In place of the output line for the digital-code signal DCODE from the authentication device 162 to the fingerprint sensor 1 in the first exemplary embodiment, output lines respectively for a start pulse SP and a clock CLK are provided in this input device. The functional structure of each section of an input device 100 is the same as in the first exemplary embodiment.

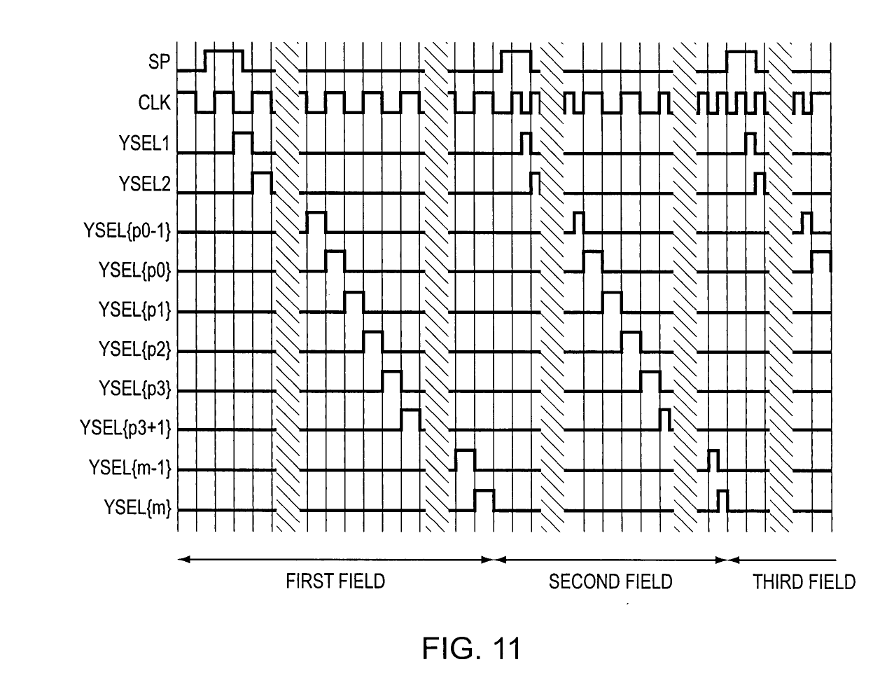

Since the mechanism for registration of fingerprint data and reading and acquisition of fingerprint information is the same as in the processing flow in FIG. 6, only the operation that differs from that in the first exemplary embodiment is described below. FIG. 11 is a timing chart of the scan driver 20 according to this exemplary embodiment. This timing chart shows that the start pulse SP applied to the fingerprint sensor 1 triggers the scanning of each field. Also, upon receiving the start pulse SP, the shift register 21 of the scan driver 20 makes all scanning lines 36 active one at a time in synchronization with the clock CLK.

In more detail, in a first step, at step S410, in order to search for the position used for authentication, the authentication device 162 reads ridge and valley information of the fingerprint from all capacitive sensing circuits 31 arranged in the active matrix 30 by scanning the first field immediately after the authentication device 162 starts. This operation is performed by the preprocessing device 172. The frequency of the clock CLK applied to the scan driver 20 and the data driver 10 is set to a standard value in the first step. The preprocessing device 172 sequentially selects all scanning lines 36 in order of YSEL1, YSEL2, . . . , YSEL{m−1}, YSEL{m} and feeds the selected scanning lines 36 one at a time with a supply voltage having the high potential VDD. Then, while one selected scanning line 36 is at the high potential VDD, the preprocessing device 172 sequentially selects and turns ON the switching elements 14 connected to all data lines 37. This enables ridge and valley information of the fingerprint to be read from all capacitive sensing circuits 31 at the intersections between the selected scanning line 36 and the selected data lines 37.

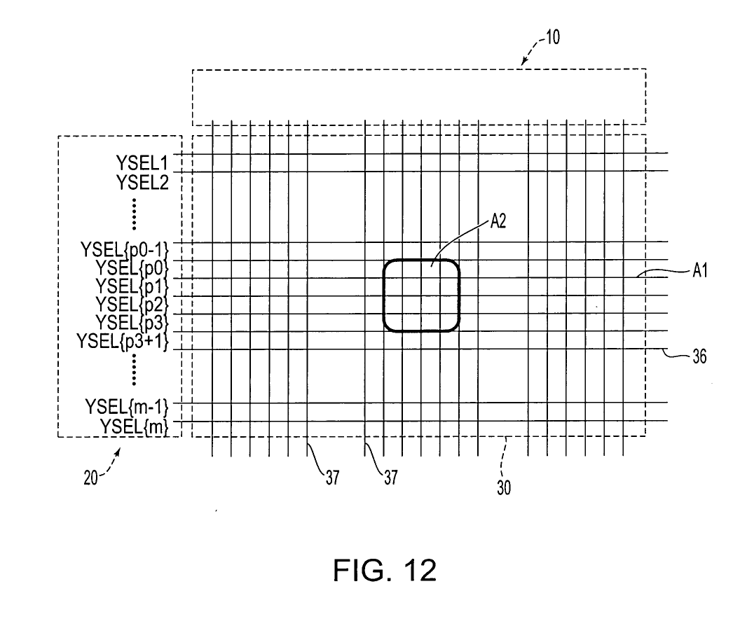

The preprocessing device 172 identifies the positions of the capacitive sensing circuits 31 necessary for fingerprint authentication based on the fingerprint information acquired through the first field scan. Here, it is assumed that the positions YSEL{p0} to YSEL{p3} of the scanning lines 36 are required for fingerprint authentication. FIG. 12 shows a portion A2 for fingerprint authentication determined by the preprocessing device 172.

In a second step, after the first field scan, the postprocessing device 174 sequentially selects and scans all scanning lines 36 in the second and the subsequent field scans. The scan driver 20, however, causes the scanning lines 36 (YSEL1 to YSEL{p0−1}, and YSEL{p3+1} to YSEL{m}), not necessary for fingerprint authentication, to be selected at high speed, while disabling the data driver 10. For fast scanning by the scan driver 20, the frequency of the clock CLK applied to the scan driver 20 is made higher than the standard value. In addition, neither the start pulse nor the pulse is applied to the data driver 10 while the clock CLK is being applied at high speed. In FIG. 1, the scanning lines 36 that are not necessary for fingerprint authentication are sequentially selected by doubling the clock frequency. In fact, high-speed operation several hundred times as fast as the clock speed is possible. For the scanning lines 36 (YSEL{p0} to YSEL{p3}) necessary for fingerprint authentication, the frequency of the clock CLK applied to the scan driver 20 is reset to the standard value which is a normal speed. At the same time, the start pulse or the clock is applied to the data driver 10 for driving to sequentially acquire fingerprint information from the capacitive sensing circuits 31 via the data lines 37 having the switching elements 14 turned ON.

As described above, according to this exemplary embodiment, the fingerprint sensor 1 can be operated faster by scanning the capacitive sensing circuits 31 not necessary for fingerprint authentication at high speed. Since the data driver 10 operates only when the scanning lines 36 corresponding to the finger position necessary for fingerprint authentication are selected, it is possible to prevent unnecessary operation of the data driver 10 and the scan driver 20, and therefore to reduce the power consumption of the fingerprint sensor 1. Furthermore, an increase in the amount of processed information can be suppressed during processing, such as authentication where fingerprint information from the fingerprint sensor 1 is used, and thereby the fingerprint authentication system can be made simple.

As described so far, according to this exemplary embodiment, there are provided a capacitive sensing circuit 31 at each of the intersections between the plurality of scanning lines 36 and the plurality of data lines 37, the scan driver 20 to sequentially scan the scanning lines 36, and the data driver 10 to sequentially connect the data lines 37 to the amp circuit 40. Here, the postprocessing device 174 drives the scan driver 20 and the data driver 10 such that all scanning lines 36 are sequentially scanned where the scanning lines 36 corresponding to the capacitive sensing circuits 31 other than the particular capacitive sensing circuits 31 are scanned faster than the scanning lines 36 corresponding to the particular capacitive sensing circuits 31 to acquire fingerprint information from the data lines 37 corresponding to the particular capacitive sensing circuit 31.

In this case, all scanning lines 36 are sequentially scanned at the second and the subsequent field scans. During this processing, however, the scanning lines 36 corresponding to the capacitive sensing circuits 31 from which fingerprint information is not acquired are scanned faster than the scanning lines 36 corresponding to the capacitive sensing circuits 31 from which fingerprint information is acquired to acquire fingerprint information from the particular capacitive sensing circuits 31. Thus, unnecessary operation associated with scanning of the capacitive sensing circuits 31 and the acquisition of fingerprint information from the data lines 37 is eliminated to reduce the power consumption associated with the driving of the capacitive sensing circuits 31.

This is also achieved by the following method in the above-described second step. That is, all scanning lines 36 are scanned such that the scanning lines 36 corresponding to the capacitive sensing circuits 31 other than the particular capacitive sensing circuits 31 are scanned faster than the scanning lines 36 corresponding to the particular capacitive sensing circuits 31 to acquire fingerprint information from the data lines 37 corresponding to the particular capacitive sensing circuits 31.

In both exemplary embodiments described above, for example, the capacitive sensing circuits 31 to detect ridges and valleys of a fingerprint are used as the sensor cells. This permits various types of control where a fingerprint is used as detected information. An extremely small and lightweight input device is provided by using the fingerprint sensor 1 for outputting fingerprint information.

Furthermore, the fingerprint sensor 1 can be applied not only to the Smart Card 81 but also to various types of electronic apparatus, such as a PDA and a mobile phone by incorporating an input device 100 including such a fingerprint sensor. This permits such electronic apparatus to be extremely small and lightweight, as well as to be suitable to, for example, the registration and authentication of a fingerprint.

The present invention is not limited to the exemplary embodiments described above, but various modifications are conceivable within the scope of the present invention. The detection object need not be a fingerprint. The present invention is applicable to various types of sensors for measuring. For example, pressure distribution or temperature distribution. A sensor of a different type from that in the exemplary embodiments, such as a sensor where capacitance is not detected, may be used as the fingerprint sensor 1. In the exemplary embodiments, fingerprint information acquired from the fingerprint sensor 1 is used to authenticate individuals. Fingerprint information may be used for other types of processing. For example, a shift of a fingerprint in six axial directions may be captured to control, for example, the movement of a pointer or the scrolling of a display image in a display device.

1. An input device, comprising:
a plurality of sensor cells arranged in a matrix;
an output device to output detected information from the sensor cells; and
a selection device to perform a plurality of field scans to read the detected information from the sensor cells, identify particular sensor cells, and read detected information for processing from the particular sensor cells.

2. The input device according to claim 1, the selection device including a preprocessing device to read the detected information from all sensor cells in the first field scan to determine particular sensor cells to be selected and a postprocessing device to read the detected information from the determined particular sensor cells in the second and the subsequent field scans.

3. The input device according to claim 2, the preprocessing device comparing the detected information read from all the sensor cells with a predetermined threshold to determine the particular sensor cells to be selected.

4. The input device according to claims 2, the sensor cells being disposed at respective intersections of a plurality of scanning lines and a plurality of data lines, the input device, further comprising a scan driver to scan the scanning lines and a data driver to connect the data lines to the output device, and
the postprocessing device driving the scan driver and the data driver such that only the scanning lines corresponding to the particular sensor cells are scanned to read the detected information only from the data lines corresponding to the particular sensor cells.

5. The input device according to claims 2, the sensor cells being disposed at respective intersections of a plurality of scanning lines and a plurality of data lines, the input device, further comprising: a scan driver to sequentially scan the scanning lines and a data driver to sequentially connect the data lines to the output device, and
the postprocessing device driving the scan driver and the data driver such that all scanning lines are scanned where the scanning lines corresponding to the sensor cells other than the particular sensor cells are scanned at a higher speed than that of the scanning lines corresponding to the particular sensor cells to read the detected information only from the data lines corresponding to the particular sensor cells.

6. The input device according to claim 1, the sensor cells detecting ridges and valleys of a fingerprint.

7. An electronic apparatus, comprising:
the input device according to claim 1.

8. A method for driving an input device to output detected information from a plurality of sensor cells arranged in a matrix, the method comprising:
performing a plurality of field scans to read the detected information from the sensor cells;
identifying particular sensor cells based on the read detected information; and
reading detected information for processing from the particular sensor cells.
